(19) United States
(12) Patent Application Publication
(10) Pub. No.: US 2022/0395002 A1
(43) Pub. Date: Dec. 15, 2022

(54) METHOD FOR DEACTIVATION OF AFLATOXINS

(71) Applicant: Jo{hacek over (z)}ef Stefan Institute, Ljubljana (SI)

(72) Inventors: Nina RECEK, Ljubljana (SI); Gregor PRIMC, Ljubljana (SI)

(73) Assignee: Jo{hacek over (z)}ef Stefan Institute, Ljubljana (SI)

(21) Appl. No.: 17/342,779

(22) Filed: Jun. 9, 2021

(51) Int. Cl. A23L 3/3445; A23B 9/22; A23K 30/00; A23L 3/3409

(52) U.S. Cl. CPC A23L 3/3445; A23B 9/22; A23K 30/00; A23L 3/34095; A23V 2002/00

(57) ABSTRACT

The aspects of the present disclosure relate to methods for energy-efficient destruction of organic toxins on the surface of any material, in particular on the surface of organic material. The material contaminated with toxins is exposed to NH₂ and H radicals. Said radicals react chemically with toxins causing their transformation to less poisonous or less carcinogenic substances, or destruction to hydrocarbons and nitrogen-containing benign molecules. Exemplary usage for treatment of seeds, grains, beans, food, feedstock.

### FIELD

The aspects of the present disclosure relate to methods for treatment of products contaminated with mould-born toxins, in particular kernel and grains that have been contaminated with mycotoxins, for example, aflatoxins. The contaminated material is treated with NH₂ radicals which almost instantly interact chemically with said toxins by forming amino-groups on molecules, thus suppressing the toxicity of the toxins.

### BACKGROUND

Improper storage of human or animal food often causes a proliferation of different moulds. The moulds grow and multiply upon excessive humidity and temperature. Some varieties of moulds produce toxins to prevent the proliferation of microorganisms other than the type of mould. These toxins are poisonous not only for the microorganisms but to humans and animals as well. There have been reports of poisoning animals in large farms fed by kernel or nuts contaminated with toxins. One of the most dangerous aflatoxins is the aflatoxin B1, which is produced by moulds Aspergillus flavus and Aspergillus parasiticus. These varieties of mould often proliferate on kernel upon relatively high humidity. Aflatoxin B1 is very potent and carcinogen. The carcinogenic potency varies across species of animals but is regarded as dangerous for all mammals, including humans. Aflatoxin B1 is a common contaminant in a variety of foods and feedstock including corn, wheat, barley and other grain, nuts, and so on. Aflatoxin B1 is considered the most toxic aflatoxin and it is highly implicated in hepatocellular carcinoma in humans. In animals, aflatoxin B1 has also been shown to be mutagenic, teratogenic, and to cause immunosuppression. Thus, the international standards prescribe the maximum tolerated levels of aflatoxin B1, for example in the range of 1-20 μg/kg in food for humans, and 5-50 μg/kg in dietary cattle feed. The aflatoxins are stable at temperatures exceeding 100° C., so even prolonged heat treatment (cooking) does not destroy them.

There are several techniques for suppressing the effects of aflatoxins. For example, CN109907209 (A) “Method for removing aflatoxin from corn” discloses a method for adding attapulgite powder. Addition of various compounds to the contaminated grains are referred to in CN109329573 (A) entitled “Pennisetum purpureum pig feed and preparation method thereof”. The addition of enzyme-rich liquid is referred to in CN109136294 (A) entitled “Method for removing fungal toxin in mouldy corn and converting to produce xylitol”. Biologically active compounds are also added in CN108208537 (A) entitled “Method for removing aflatoxin B1”. The addition of other chemicals can provide beneficial results as disclosed in CN107668199 (A) entitled “Application of sorbaldehyde as a natural anti-mould agent in grain storage”. The use of harsh chemicals are also referred to in CN106472824 (A) entitled “Method and equipment for removing toxins of corn germ meal by alcohol method”. A similar method is referred to in CN105647978 (A) entitled “Method for degrading aflatoxin in raw corn material”.

Application of high temperature, high-pressure water steams is referred to in CN107083270 (A) entitled “Method for removing mycotoxin in production process of corn oil”. CN208679950 (U) entitled “Kernel of corn belt cleaning device with remove mould function” refers to a mechanical cleaning method. A similar (mechanical) technique is referred to in CN109174748 (A) entitled “Rotor suitable for coarse cereal brushing machine”. Another mechanical, method for removal of grains heavily contaminated with mycotoxins, is referred to in U.S. Pat. No. 8,919,569 (B2) entitled “Method and apparatus for reducing aflatoxin-contaminated corn”. Irradiation with soft ultraviolet rays (peaking at 356 nm) is referred to in CN109540823 (A) entitled “Method for detecting aflatoxin in corn feed stored in farm”.

Like all other organic molecules, aflatoxins react with strong oxidising agents. For example, treatment with ozone causes oxidation of the organic molecule and thus resulting in suppression or even annihilation of its poisonous character. It is believed that ozone molecule interacts chemically with one of the aromatic rings of aflatoxin molecule forming aflatoxin ozonide. The aflatoxin ozonide is unstable even at room temperature and converts spontaneously to other organic molecules such as aldehydes, ketones, acids. Total oxidation to carbon dioxide and water has been reported in the case of prolonged exposure of aflatoxin to ozone, too. The interaction mechanism upon treatment of aflatoxin B1 with ozone was reported by Luo et all in 2013 [Xiaohu Luo, Ren Wang, Li Wang, Yong Wang, Zhengxing Chen, Food Control 31 (2013) 331e336]. Ozonisation is a slow process at room temperature, so the required treatment times for appropriate destruction are hours if not days. Such a prolonged treatment is not practical due to the high costs of ozone, so the method is suitable only for decontamination of small quantities of agricultural products. Ozonisation is also referred to in patent application MX2016000314 (A) entitled “Treatment of liquid gluten slurry to reduce or remove aflatoxin”.

Another chemical method for modification of aflatoxins to form benign molecules is ammoniation. The contaminated products are exposed to gaseous ammonia (NH₃) for a prolonged time. It is believed that ammonia molecules interact with the aflatoxins by breaking the bonds of the lactone rings. The result of the chemical interaction is the formation of an amino (NH₂) group on one of the carbon atoms forming the original lactone ring, and the dangling bond of oxygen atom captures a hydrogen atom to form the hydroxyl (OH) group on another carbon atom of the original lactone ring. The aflatoxin molecule thus transforms to aflatoxin ammonium salt, which is regarded as benign for humans or animals. The ammoniation, therefore, enables the destruction of the aflatoxins, but as in the case of ozonisation, the process is slow at room temperature, so the required treatment times for appropriate destruction are hours if not days.

The intensity of chemical reactions can depend on temperature. The reaction time between the ammonia and the aflatoxins decreases with increasing temperature but remains long even at 100° C. for both ozonisation and ammoniation. The prohibitively long reaction time is because there is a potential barrier for chemical interaction. Namely, the original NH₃ molecule should be dissociated to NH₂ and H radicals so that the NH₂ radicals bond chemically to the carbon atom in the original lactone ring, and H radicals bond chemically to the oxygen atom in the original lactone ring. A method for using ammonia for reduction of aflatoxin concentration is referred to in U.S. Pat. No. 5,082,679 (A) entitled “Method for detoxifying foodstuffs”, as well as in NL9000367 (A) entitled “Inactivating mycotoxin in particulate raw material for foodstuff by compressing to expel air, treating with ammonia and steam in reaction chamber, and compressing to expel ammonia and water” and IT1051429 (B) entitled “Extracting oil-contg seeds—with hydrocarbon while contacting with gaseous ammonia to give aflatoxin free cake”.

### SUMMARY

The patentable scope of the present disclosure is defined by the claims.

The present disclosure is directed to a method for treatment of toxins using gaseous ammonia as the precursor. The problem of slow interaction between the ammonia and toxin molecules is overcome by dissociation of the ammonia molecules before they reach the toxins. The toxins are therefore not treated with NH₃ molecules but preferably with NH₂ and H radicals. The NH₂ radicals from the gas phase interact with a carbon atom in the original lactone ring, and the H atoms from the gas phase interact with the oxygen atom in the original lactone ring. Since there is no potential barrier for said chemical reactions, the reactions are immediate and faster than using NH₃ molecules. The interaction between the toxins and NH₂ and H radicals preferably occurs at ambient temperature, often the storage temperature or the room temperature, i.e., between 0 and 25° C.

In one embodiment is a method for the destruction of toxins, wherein the material contaminated with toxins is exposed to NH₂ and H radicals.

In another embodiment is a method for the destruction of toxins, wherein the material contaminated with toxins is perfused with NH₂ and H radicals.

In another embodiment is a method for the destruction of toxins where the material contaminated with toxins include seeds, grains, beans, nuts, food or any feedstock, or any other organic or inorganic material.

In another embodiment is a method for destruction of aflatoxins on the surface of any organic material according to any of the preceding claims, wherein the fluence of NH₂ and H radicals onto the surface of organic material is above about 3×10²² radicals per square meter per micrometer thickness of the toxin layer, preferably above about 3×10²³ radicals per square meter per micrometer thickness of the toxin layer.

In another embodiment is a device for the destruction of toxins, wherein the device employs NH₂ and H radicals.

In another embodiment is a device for the destruction of toxins comprising of a discharge chamber and a reaction chamber, wherein the NH₂ and H radicals are created within a discharge chamber and drifted into a reaction chamber by a pressure gradient, the pressure gradient existing along both the discharge and the reaction chambers, the reaction chamber containing any material contaminated with organic toxins.

In another embodiment is the use of any method or device of the present disclosure for decontamination of seeds, grains, beans, nuts or any other food or feedstock.

In another embodiment, a method for the decontamination of material contaminated with a toxin including a lactone ring is provided. The method includes using a gaseous precursor capable of being dissociated into NH₂ and H radicals; dissociating the gaseous precursor into NH₂ and H radicals; and exposing the material contaminated with the toxin including a lactone ring to NH₂ and H radicals.

In another embodiment, a method for the decontamination of material contaminated with a toxin including a lactone ring is provided. The method includes using a gaseous precursor capable of being dissociated into NH₂ and H radicals, wherein the gaseous precursor is ammonia (NH₃) or a mixture of nitrogen (N₂) and hydrogen (H₂); dissociating the gaseous precursor into NH₂ and H radicals; and exposing the material contaminated with the toxin including a lactone ring to NH₂ and H radicals.

In another embodiment, a system for the decontamination of material contaminated with a toxin including a lactone ring is provided. The system includes a source of a gaseous precursor capable of being dissociated into NH₂ and H radicals; a dissociation chamber that is in fluid communication with the source of the gaseous precursor and capable of dissociating the gaseous precursor into NH₂ and H radicals; a reaction chamber having a configuration so as to contain the material contaminated with the toxin including a lactone ring and expose the material contaminated with the toxin including a lactone ring to the NH₂ and H radicals, the reaction chamber being in fluid communication with the dissociation chamber; and a vacuum device capable of forming a pressure gradient along both the discharge and the reaction chambers to enable the flow of the NH₂ and H radicals from the dissociation chamber to the reaction chamber so as to expose material contaminated the toxin including a lactone ring present in the reaction chamber to the NH₂ and H radicals.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 shows a schematic of the chemical interaction of the NH₂ and H radicals upon treatment of an aflatoxin (e.g., aflatoxin B1) and the lactone ring thereof.

FIG. 2 is a schematic of one embodiment of a system of the present disclosure to practice method embodiments of the present disclosure.

FIG. 3 is a graph that shows a typical pressure along the system presented schematically in FIG. 2.

FIG. 4 is a graph that shows the reaction time for 90% degradation of the aflatoxins B1 versus the temperature of the grains in the reaction chamber according to Example 1.

FIG. 5 is a graph that shows the reaction time for 90% degradation of the aflatoxins B1 versus the temperature of the grains in the reaction chamber according to Example 2 at three different plasma powers: 500, 1000, and 1500 W.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by embodiments of the present disclosure. As used herein, “about” may be understood by persons of ordinary skill in the art and can vary to some extent depending upon the context in which it is used. If there are uses of the term which are not clear to persons of ordinary skill in the art, given the context in which it is used, “about” may mean up to plus or minus 10% of the particular term.

The aspects of the present disclosure relate to methods for chemical modification of toxins including toxins that have a lactone ring to benign molecules using NH₂ and H radicals including toxins (for example, aflatoxins, e.g., aflatoxin B1, G1, M1, B2, G2 and M2, ochratoxins and zearalenone (ZEN)) contaminated kernels, grains, beans, nuts and other agricultural products and materials (e.g., foods and feedstock including corn, wheat, barley and other grain, nuts, etc.) contaminated with toxins. In one embodiment, the source of NH₂ and H radicals the gaseous precursor is the gaseous precursor ammonia (NH₃). In another embodiment, the source of NH₂ and H radicals is the gaseous precursor a mixture of nitrogen (N₂) and hydrogen (H₂). In both embodiments, an electrical discharge is sustained in the dissociation chamber (203) in order to facilitate the formation of NH₂ and H radicals.

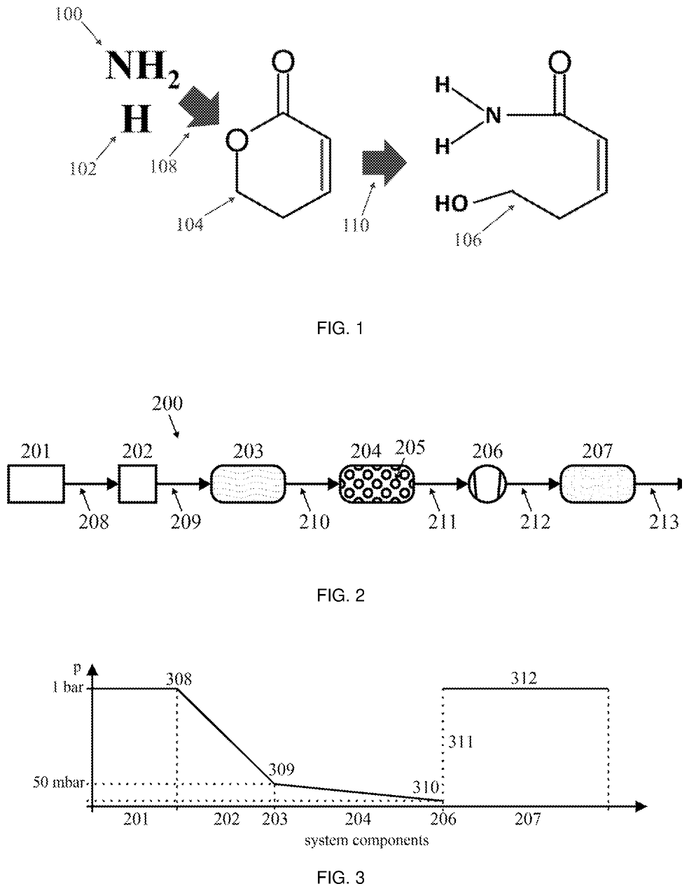

FIG. 1 illustrates an embodiment of the present disclosure including a schematic of the chemical interaction of NH₂ (100) and H (102) radicals and the lactone ring of a toxin (104), for example, an aflatoxin (e.g., aflatoxin B1) upon which the NH₂ (100) and H (102) radicals react. Upon treatment of the lactone ring of the toxin (104) by the NH₂ (100) and H (102) radicals, the lactone ring (104) opens up to form substituent (106). The arrows (108) and (110) in FIG. 1 indicate the direction of the reaction.

Another embodiment of the present disclosure is a system 200 that includes a gas inlet system (201) that supplies the gaseous precursor through a valve (202) into the dissociation chamber (203) where gaseous radicals are formed. The gas flow with the gaseous radicals formed in the dissociation chamber (203) continues from the dissociation chamber (203) into the reaction chamber (204), which contains the material to be decontaminated (205), typically kernels, grains, beans or nuts and other agricultural products and materials (e.g., foods and feedstock including corn, wheat, barley and other grain, nuts, etc.). The gaseous radicals react with the contaminant of the material to be decontaminated (205) to decontaminate it. Exposure of the surface of the material contaminated with a toxin having a lactone ring, for example, an aflatoxin to NH₂ and H radicals can be in an amount of from about 1×10²² radicals per square meter per micrometer thickness of the toxin layer to about 1×10²⁵ radicals per square meter per micrometer thickness of the toxin layer, preferably above about 3×10²² radicals per square meter per micrometer thickness of the toxin layer or even above about 3×10²³ radicals per square meter per micrometer thickness of the toxin layer. The reaction chamber (204) is pumped with a vacuum pump (206) to enable the flow of introduced gas through the system. The exhaust of the vacuum pump (206) then passes through a catalyzer (207) so that the excess gaseous radicals formed in the dissociation chamber (203) that flow into reaction chamber (204) to be used to decontaminate the material to be decontaminated (205) and are not utilized therein as well as other chemical species formed in the reaction chamber (204) and which may be hazardous are pumped out of the reaction chamber (204) using the vacuum pump (206) and are converted into ecologically benign species, molecules and other chemical forms before being exhausted from system 200 in the direction of arrow (213). The arrows (208), (209), (210), (211), (212) and (213), in FIG. 2 indicate the directional flow of system 200.

In another embodiment, ammonia is a gaseous precursor used to create suitable concentrations of NH₂ and H radicals and react with the lactone ring of a toxin as shown in FIG. 1. For example, in the embodiment of FIG. 2, ammonia of commercial purity is introduced from the inlet system (201) to the dissociation chamber (203) through a needle valve (202). The gas pressure in the inlet system could be from about 0.5 bars to about 10 bars or from about 1 bar to about 10 bars, but in the preferred embodiment, it is about 1 bar. The entire system in the embodiment of FIG. 2, for this example, is preferably hermetically tight. The vacuum pump (206) enables the flow of introduced gas through the system in FIG. 2, indicated with arrows (208), (209), (210), (211), (212) and (213). The dissociation chamber (203) includes sustaining of an electrical discharge. Preferably, the electrical discharge is an electrode-less discharge, such as a microwave (MW) discharge or a radio-frequency (RF) discharge. The amount of the electrical discharge power can be from about 50 W (W=Watts) to about 2000 W or from about 200 W to about 500 W. The ammonia molecules passing the electrical discharge zone in the dissociation chamber (203) are subject to plasma electrons. The plasma electrons cause ionization and dissociation of ammonia molecules introduced into the discharge chamber (203) through the needle valve (202). The geometry of the dissociation chamber is such that there is an almost constant gradient of gas pressure along the dissociation chamber (203) as shown in FIG. 3 which graphs pressure versus system components. FIG. 3 shows a graph of the typical pressure along the system illustrated in FIG. 2. The inlet pressure can be from about 0.5 bars to about 10 bars or typically about 1 bar up to about 1.5 bar. The knee on the curve (308) occurs at the valve (202). The pressure keeps decreasing along the dissociation chamber (203) until the knee (309), which occurs between the dissociation chamber (203) and the reaction chamber (204). The pressure further decreases along the reaction chamber (204) and reaches the minimal value (310) at the entrance to the vacuum pump (206). There is a pressure jump (311) across the vacuum pump (206), and the pressure assumes the initial value after that (312).

The condition of an almost constant gradient of gas pressure along the dissociation chamber (203) between the knees (308) and (309) of FIG. 3 can be achieved by using a tube of a rather small diameter, for example about 1 cm, and an appropriate pumping speed of the vacuum pump (206), for example about 100 m³/h. A typical pressure at the exhaust of the dissociation chamber (203) and the entrance of the reaction chamber (204) is from about 1 mbar (mbar=millibar) to about 100 mbar or from about 5 mbar to about 100 mbar, preferably about 50 mbar as shown in FIG. 3. The initial pressure drop is, therefore, along with the dissociation chamber (203) as shown in FIG. 3.

Such a distribution of pressure between the knees (308) and (309) of FIG. 3 was found particularly beneficial since it allows for optimal efficiency of the gaseous discharge in terms of producing NH₂ and H radicals. The large pressure gradient along with the dissociation chamber (203) also enables a high speed of gas along with the dissociation chamber (203). In a preferred embodiment, the speed of gas drifting along with the dissociation chamber (203) is from about 50 m/s (m/s=meters per second) to about 343 m/s, from about 50 m/s to about 343 m/s, about 200 m/s to about 300 m/s or about 100 m/s, so the residence time of gaseous molecules and radicals in the dissociation chamber (203) is minimized, typically from about 0.6 ms (ms=millisecond) to about 4 ms, or well below 1 second. The gas drifts from the dissociation chamber (203) to the reaction chamber (204) due to continuous pumping with the vacuum pump (206). The cross-section of the reaction chamber (204) is substantially larger than the cross-section of the dissociation chamber (203) which results in a smaller pressure gradient along with the reaction chamber (204), as revealed from FIG. 3 (the curve between the knees (309) and (310). The residence time of gaseous molecules and radicals is, therefore, longer in the reaction chamber (204) than in the dissociation chamber (203). Such conditions were found beneficial since the moderately large residence time (from about 0.1 s (s=second) to about 10 s or from about 1 s to about 3 s (about 1 second in the preferred embodiment) in the reaction chamber (204) provides enough time for chemical interaction between the NH₂ and H radicals and the organic matter (205) placed inside the reaction chamber (204). Typical organic material (205) placed into the reaction chamber (204) can include kernels, grains, nuts and other agricultural products and materials (e.g., foods and feedstock including corn, wheat, barley and other grain, nuts, etc.) contaminated with toxins. The NH₂ and H radicals interact with toxins present on the organic material (205) according to the scheme shown in FIG. 1. Some radicals cause reactions other than that of FIG. 1. For example, some NH₂ radicals may cause etching of organic material (205) forming different molecules. The most straightforward etching product is hydrogen cyanide (HCN). Hydrogen cyanide is very poisonous for both microorganisms and mammals, so it should not be released to the environment. The vacuum pump (206) enables drifting the gas from the inlet (201) through the dissociation chamber (203) and the reaction chamber (204). In preferred embodiments, the vacuum pump (206) uses mineral oil as a lubricant. The mineral oil is heated to about 60° C. upon the operational temperature of the vacuum pump (206). The hydrogen cyanide interacts chemically with the mineral oil at 60° C., but the interaction may not lead to the complete destruction of HCN. Any poisonous products that are not captured by the pump are converted to benign molecules by passing compressed gas from the vacuum pump (206) to the environment through the catalyzer (207).

The NH₂ and H radicals are unstable at ambient conditions. Some of the radicals are lost in the gas phase or on any surfaces they touch. The loss on the surface of toxins is beneficial since it leads to the reaction presented in FIG. 1. The loss in the gas phase occurs at three-body collision to assure for the conservation of total energy and momentum:

NH₂+H+particle→NH₃+particle+excessive energy.

The particle can be any molecule or other radicals, for example, NH₃, H₂, NH₂, NH, H. The excessive energy is close to the dissociation energy of the ammonia molecule to NH₂ and H radicals. The excessive energy is shared between the particle and the ammonia molecule, either as kinetic energy or internal energy providing the internal energy does not equal or exceed the dissociation energy. The loss of radicals in the absence of the particle is highly improbable since the excessive energy cannot appear in the form of the kinetic energy (since the momentum should be conserved), and since it cannot appear in the form of internal energy (since the formed ammonia molecule would dissociate immediately). The frequency of three-body collisions increases as the square of the pressure. At atmospheric pressure, it is prohibitively high resulting in association of the radicals in the gas phase to ammonia molecule in a microsecond. At the pressure of 1 mbar, however, the collision frequency is low enough to assure for the life-time about 1 second. The preferred pressure in the reaction chamber is, therefore, as low as possible. At low pressure, however, the density of gaseous molecules or radicals is low and so is the flux of radicals onto the surface of any material. The pressure of few millibar (for example, from about 1 mbar to about 100 mbar or from about 5 mbar to about 100 mbar, preferably about 50 mbar) at the entrance to the reaction chamber (204) was found a useful compromise between the loss of radicals in the gas phase and the efficacy of chemical reactions as in FIG. 1.

The NH₂ and H radicals are preferably created by electron impact dissociation of ammonia molecules. The dissociation energy of the bond H—NH₂ is about 435 kJ/mol, which corresponds to a few eV per bond. Such high dissociation energy prevents the application of mostly used dissociation technique, i.e., thermal dissociation on a hot surface. Furthermore, the thermal dissociation may involve the formation of the N₂H₄ molecule, which is regarded as problematic to dissociate and thus form NH₂ radicals. Namely, the N₂H₄ molecules are likely to separate to N₂ and H₂ molecules rather than to NH₂ and H radicals. When electron impact dissociation is employed, it is beneficial to use electrons of moderate energy. Electrons in gaseous discharge assume a range of energies with a distribution close to the normal (i.e., Maxwell-Boltzmann) distribution. The average electron energy in such a distribution is often expressed in terms of the electron temperature. The electron temperature depends on numerous parameters, including the density of discharge power (power normalized to the discharge volume) and the pressure. As a general rule, the electron temperature decreases with increasing pressure at a fixed power density. The pressure distribution as presented in FIG. 2 is beneficial since the electron temperature in the dissociation chamber (203) close to the needle valve (202) is too low to cause significant dissociation of ammonia molecules what would cause unwanted loss of the radicals in the gas phase. Because of the pressure gradient (in one embodiment of FIG. 2) the electron temperature increases in the dissociation chamber from the needle valve (202) towards the reaction chamber (204) reaching the optimal value just before the exhaust from the dissociation chamber (203) to the reaction chamber (204). The electron temperature of between about 2 and about 3 eV at the exhaust from the dissociation chamber (203) to the reaction chamber (204) was found particularly useful.

The catalyzer (207) serves for the conversion of excessive radicals and other poisonous compounds that might be formed in the reaction chamber (204) upon treatment with organic material (205). The catalyzer (207) typically contains a network or mesh coated with an appropriate catalyst. Optionally, the catalyzer (207) is heated to an elevated temperature (for example, due to the exothermic reactions occurring on the surface of from about 100° C. to about 500° C., usually about 100° C.) to assure for thermal destruction of poisonous gases that might be formed in the reaction chamber (204) upon the interaction of the NH₂ radicals with the organic matter (5).

### Example 1

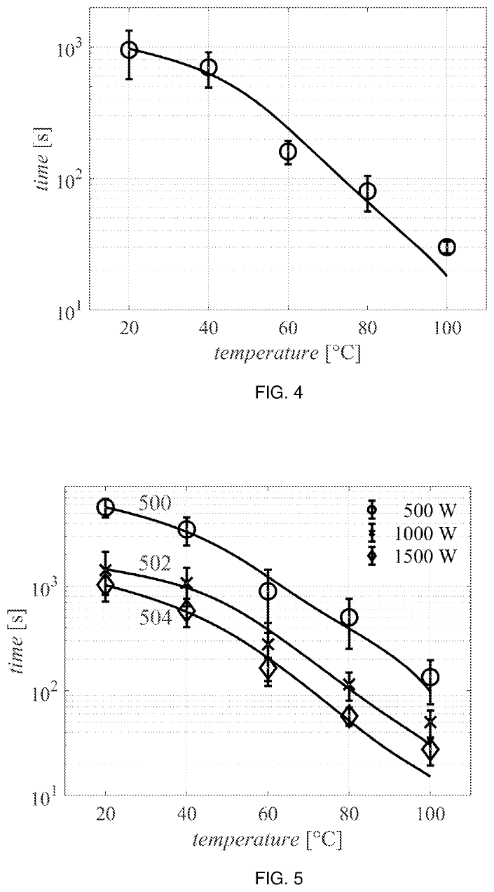

The configuration presented in FIG. 2 was used for Example 1. The gas inlet (201) in this example was equipped with pressurised ammonia from a metallic flask and a suitable valve that reduces the pressure from that in the bottle (about 8 bar) to 1 bar. The valve (202) was a vacuum-compatible needle valve of adjustable throughput in the range up to about 10 slm (standard litres per minute). The discharge tube of the dissociation chamber (203) had a diameter of about 1 cm and was made from quartz glass. An inductively coupled RF discharge was used as a plasma source. The discharge power was about 500 W. The discharge tube of the dissociation chamber (203) stretches into the reaction chamber (204). The reaction chamber (204) was made from aluminium and is a cubicle of the linear dimension of about 40 cm. The vacuum pump (206) was a combination of a roots blower backed with a two-stage oil-sealed rotary pump. The nominal pumping speed of the roots blower and the rotary pump was about 600 m³/h and about 80 m³/h, respectively. The grains material to be decontaminated (205) were evenly distributed in the reaction chamber (203). They had been contaminated artificially with aflatoxins before the treatment. The reaction time for 90% degradation of the aflatoxins B1 versus the temperature of the grains in the reaction chamber (204) is shown in FIG. 4.

### Example 2

The configuration presented in FIG. 2 was also used for Example 2, except that the ammonia in the inlet (201) was replaced with a mixture of hydrogen and nitrogen. The mixture was 25 vol % (volume %) N₂ and 27 vol % H₂. Gases of commercial purity were used. The reaction time for 90% degradation of the aflatoxins B1 versus the temperature of the grains in the reaction chamber (203) is shown in FIG. 5—highest curve (500). The reaction time is too long at the power of 500 W, so higher discharge powers were also used. The highest curve (500) was obtained at the discharge power of 500 W, the middle curve (502) at 1000 W and the lowest curve (504) at 1500 W. The immense discharge power is therefore beneficial for the destruction of aflatoxins, but the results are not as good as when using ammonia as the precursor. Without wishing to be bound by theory, it may be that ammonia is a more suitable source of NH₂ radicals than a gas mixture of N₂ and H₂ since in the latter case the formation of the NH₂ radicals is only feasible by dissociation of the N₂ molecules to N atoms, and subsequent interaction of the N atoms with hydrogen atoms, probably on the surfaces. The triple bond between N atoms in the nitrogen molecule is very strong, hence beneficial dissociation occurs only at high discharge powers.

1. A method for the decontamination of a material contaminated with a toxin including a lactone ring, the method comprising:
using a gaseous precursor capable of being dissociated into NH₂ and H radicals;
introducing the gaseous precursor into a first chamber;
dissociating the gaseous precursor into the NH₂ and H radicals in the first chamber;
forming a pressure gradient along the first chamber and a second chamber to transfer the NH₂ and H radicals from the first chamber to the second chamber; and
exposing the material contaminated with the toxin including the lactone ring to the NH₂ and H radicals in the second chamber.

2. The method of claim 1, wherein the material contaminated with the toxin including the lactone ring includes seeds, grains, beans, nuts, food, feedstock, or other organic or inorganic material including the toxin including the lactone ring.

3. The method of claim 1, wherein the toxin including the lactone ring is on a surface of a material contaminated with aflatoxin.

4. The method of claim 1, further including exposing a surface of a material contaminated with the toxin including the lactone ring to the NH₂ and H radicals in an amount above about 3×10²² radicals per square meter per micrometer thickness of a toxin layer.

5. The method of claim 1, wherein further includes exposing a surface of the material contaminated with the toxin including the lactone ring to the NH₂ and H radicals in an amount above about 3×10²³ radicals per square meter per micrometer thickness of a toxin layer.

6. The method of claim 1, wherein the toxin including the lactone ring is an aflatoxin including aflatoxins B1, G1, M1, B2, G2 and M2.

7. The method of claim 1, wherein the toxin including the lactone ring is an aflatoxin.

8. A method for the decontamination of a material contaminated with a toxin including a lactone ring, the comprising:
using a gaseous precursor capable of being dissociated into NH₂ and H radicals, wherein the gaseous precursor is ammonia (NH₃) or a mixture of nitrogen (N₂) and hydrogen (H₂);
introducing the gaseous precursor into a first chamber;
dissociating the gaseous precursor into the NH₂ and H radicals in the first chamber;
forming a pressure gradient along the first chamber and a second chamber to transfer the NH₂ and H radicals from the first chamber to the second chamber; and
exposing the material contaminated with the toxin including a lactone ring to the NH₂ and H radicals in the second chamber.

9. The method of claim 8, wherein the material contaminated with the toxin including the lactone ring includes seeds, grains, beans, nuts, food, feedstock, or other organic or inorganic material including the toxin including the lactone ring.

10. The method of claim 8, wherein the toxin including the lactone ring is on a surface of a material contaminated with aflatoxin.

11. The method of claim 8, further including exposing a surface of a material contaminated with the toxin including the lactone ring to the NH₂ and H radicals in an amount above about 3×10²² radicals per square meter per micrometer thickness of a toxin layer.

12. The method of claim 8, wherein further includes exposing a surface of the material contaminated with the toxin including the lactone ring to the NH₂ and H radicals in an amount above about 3×10²³ radicals per square meter per micrometer thickness of a toxin layer.

13. The method of claim 8, wherein the toxin including the lactone ring is an aflatoxin including aflatoxins B1, G1, M1, B2, G2 and M2.

14. The method of claim 8, wherein the toxin including the lactone ring is an aflatoxin.

15. A system for the decontamination of material contaminated with a toxin including a lactone ring, comprising:
a source of a gaseous precursor capable of being dissociated into NH₂ and H radicals;
a dissociation chamber that is in fluid communication with the source of the gaseous precursor and capable of dissociating the gaseous precursor into NH₂ and H radicals;
a reaction chamber having a configuration so as to contain the material contaminated with the toxin including a lactone ring and expose the material contaminated with the toxin including a lactone ring to the NH₂ and H radicals, the reaction chamber being in fluid communication with the dissociation chamber; and
a vacuum device capable of forming a pressure gradient along both the discharge and the reaction chambers to enable the flow of the NH₂ and H radicals from the dissociation chamber to the reaction chamber so as to expose material contaminated with the toxin including a lactone ring present in the reaction chamber to the NH₂ and H radicals.

16. The system of claim 15, wherein the material contaminated with the toxin including a lactone ring includes seeds, grains, beans, nuts, food, feedstock, or other organic or inorganic material.

17. The system of claim 15, further including a valve disposed between the source of the gaseous precursor and the dissociation chamber and in fluid communication with both and capable of controlling the flow of the gaseous precursor from the source of the gaseous precursor to the dissociation chamber.

18. The system of claim 15, further including a catalyzer that is in fluid communication with the vacuum device and capable of receiving excess NH₂ and H radicals not used in the reaction chamber and other chemical species formed in the reaction chamber and converting them into ecologically benign chemical forms.
